(19) United States
(12) Patent Application Publication
(10) Pub. No.: US 2026/0089297 A1
(43) Pub. Date: Mar. 26, 2026

(54) EXPOSURE ADJUSTMENT METHOD, IMAGE CORRECTION METHOD, AND EXPOSURE ADJUSTMENT SYSTEM

(71) Applicant: SEIKO EPSON CORPORATION, Tokyo (JP)

(72) Inventors: Eisuke SAKAMOTO, MATSUMOTO-SHI (JP); Masataka YOSHIDA, AZUMINO-SHI (JP)

(21) Appl. No.: 19/332,499

(22) Filed: Sep. 18, 2025

(30) Foreign Application Priority Data
Sep. 20, 2024 (JP) 2024-163357

(51) Int. Cl. H04N 9/31

(52) U.S. Cl. CPC H04N 9/3182; H04N 9/3185

(57) ABSTRACT

An information processing apparatus acquires a captured image from a first projection system, the captured image being a result of capturing an image of a range covering a projection receiving surface on which an image is projected; displays the acquired captured image on a touch panel; accepts a first operation of correcting a shape and a position of a non-mask region in the captured image; sets the non-mask region in the captured image based on the first operation, calculates a target value of exposure adjustment based on the captured image in the non-mask region, and outputs the calculated target value to the first projection system, and the first projection system performs the exposure adjustment based on the target value.

### CROSS REFERENCE TO RELATED APPLICATIONS

The present application is based on, and claims priority from JP Application Serial Number 2024-163357, filed September 20, 2024, the disclosure of which is hereby incorporated by reference herein in its entirety.

### BACKGROUND

### 1. Technical Field

The present disclosure relates to an exposure adjustment method, an image correction method, and an exposure adjustment system.

### 2. Related Art

There is a known technology for correcting the position and the shape of a projection image projected by a projection apparatus by using a captured image captured by an camera.

For example, JP-A-2022 092169 discloses a projector including an acquisition portion, a first derivation portion, a second derivation portion, and a correction portion.

The acquisition portion acquires a first captured image and a second captured image.

The first derivation portion derives a first mapping relationship and a second mapping relationship.

The second derivation portion derives a projection conversion parameter.

The correction portion corrects a projection image based on the first mapping relationship, the second mapping relationship, and the projection conversion parameter.

JP-A-2022-092169 is an example of the related art.

However, when the projection system disclosed in JP-A-2022-092169 acquires, for example, a captured image which is captured by an camera and part of which contains external light having entered the room, and corrects the projection image, the accuracy of the correction of the projection image may decrease. The reason for this is that the captured image has a region where the luminance is higher than that of the image projected by the projection apparatus, and in the captured image on which exposure adjustment has been performed with respect to the luminance of the high luminance region, the image projected by the projection apparatus is displayed dark, so that the image projected by the projection apparatus is detected from the captured image with reduced accuracy.

### SUMMARY

An exposure adjustment method according to an aspect of the present disclosure is an exposure adjustment method including: causing a control apparatus to acquire a captured image from an camera, the captured image being a result of capturing an image of a range covering a projection receiving surface onto which an image is projected, display the acquired captured image, accept a first operation of correcting a shape and a position of a non-mask region in the captured image, set the non-mask region in the captured image based on the first operation, calculate a target value of exposure adjustment based on the non-mask region in the captured image, and output the calculated target value to the camera; and causing the camera to adjust a set value of at least one of a shutter speed, a gain, and an aperture of the camera based on the target value.

An image correction method according to another aspect of the present disclosure is an image correction method including: causing a first projection apparatus to project a guide image used to guide setting of a non-mask region; causing a control apparatus to acquire a first captured image from an camera, the first captured image being a result of capturing an image of a range covering the projected guide image; causing the control apparatus to display the acquired first captured image; causing the control apparatus to accept a first operation of correcting a shape and a position of the non-mask region set based on the guide image displayed in the first captured image; causing the control apparatus to set the non-mask region in the first captured image based on the first operation; causing the control apparatus to calculate a target value of exposure adjustment based on the non-mask region in the first captured image; causing the control apparatus to output the calculated target value to the camera; causing the camera to adjust a set value of at least one of a shutter speed, a gain, and an aperture of the camera based on the target value; causing a first projection apparatus to project a first pattern image having a preset pattern; causing the control apparatus to acquire a second captured image captured with the camera the set value of which is adjusted based on the target value and including the first pattern image; causing a second projection apparatus to project a second pattern image having a preset pattern; causing the control apparatus to acquire a third captured image captured with the camera the set value of which is adjusted based on the target value and including the second pattern image; and causing the control apparatus to correct a shape of an image projected by at least one of the first projection apparatus and the second projection apparatus based on the second captured image and the third captured image.

An exposure adjustment system according to another aspect of the present disclosure is an exposure adjustment system including: a control apparatus including an acquisition portion configured to acquire a captured image from an camera, the captured image being a result of capturing an image of a range covering a projection receiving surface onto which an image is projected, a display screen configured to display the acquired captured image, an operation portion configured to accept a first operation of correcting a shape and a position of a non-mask region in the captured image, and a controller configured to set the non-mask region in the captured image based on the first operation, calculate a target value of exposure adjustment based on the non-mask region in the captured image, and output the calculated target value to the camera; and the camera configured to adjust a set value of at least one of a shutter speed, a gain, and an aperture of the camera based on the target value.

### BRIEF DESCRIPTION OF THE DRAWINGS

FIG. 1 shows a system configuration.

FIG. 2 is a block diagram showing the configuration of a projection system.

FIG. 3 is a block diagram showing the configuration of an information processing apparatus.

FIG. 4 is a flowchart showing operations of the information processing apparatus.

FIG. 5 shows an example of a first APP screen.

FIG. 6 shows an example of a second APP screen.

FIG. 7 shows a first projection image and a second projection image after projection position adjustment.

FIG. 8 shows an example of a third APP screen.

FIG. 9 shows an example of a guide image.

FIG. 10 shows an example of a fourth APP screen.

### DESCRIPTION OF EMBODIMENTS

### 1. System configuration

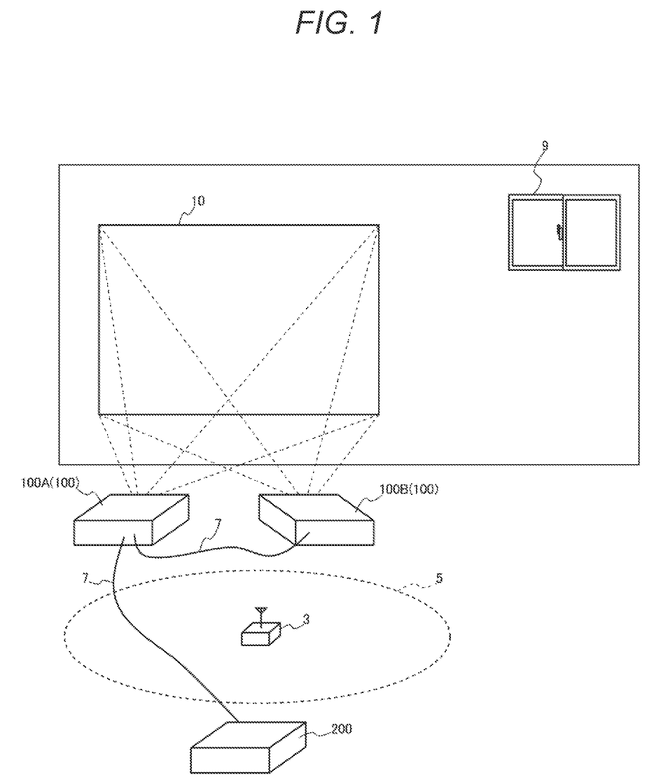

FIG. 1 shows a system configuration of a system to which the present disclosure is applied. FIG. 1 shows a system including multiple projection systems 100, and an information processing apparatus 200, which operates as a control apparatus.

The system shown in FIG. 1 includes two projection systems, a first projection system 100A and a second projection system 100B, as the projection systems 100. The number of the projection systems 100 that constitute the system is not limited to two. For example, the system may include three or more projection systems 100. In the following description, the first projection system 100A and the second projection system 100B are collectively referred to as the projection systems 100. The first projection system 100A corresponds to a first projection apparatus, and the second projection system 100B corresponds to a second projection apparatus.

The first projection system 100A, the second projection system 100B, and the information processing apparatus 200 are connected to a wireless network 5 provided by a wireless router 3. The wireless router 3 functions as an access point and relays transmission and reception of data between apparatuses connected to the wireless network 5. The wireless router 3 further functions as a router, is connected to a network such as the Internet via a modem that is not shown, and relays transmission and reception of data between an apparatus connected to the network and an apparatus connected to the wireless network 5. The information processing apparatus 200 transmits and receives control information that will be described later and captured images to and from the first projection system 100A and the second projection system 100B via the wireless network 5. The first projection system 100A and the information processing apparatus 200 constitute an exposure adjustment system.

The information processing apparatus 200, the first projection system 100A, and the second projection system 100B are coupled to each other via cables 7 in the daisy-chain arrangement. The cables 7 comply, for example, with a standard such as HDMI (high-definition multimedia interface), DisplayPort, and USB Type-C. HDMI is a registered trademark. The information processing apparatus 200 transmits an image signal to the first projection system 100A via the cable 7. The first projection system 100A receives and processes the image signal transmitted from the information processing apparatus 200, and transmits the received image signal to the second projection system 100B via the cable 7.

The information processing apparatus 200, the first projection system 100A, and the second projection system 100B may be connected to each other only via the wireless network 5. That is, the information processing apparatus 200 may be configured to transmit the control information and the image signal to the first projection system 100A and the second projection system 100B via the wireless network 5. The information processing apparatus 200, the first projection system 100A, and the second projection system 100B may be connected to each other via a wired local area network (LAN).

Examples of the information processing apparatus 200 may include a laptop personal computer (PC), a desktop PC, a tablet PC, a smartphone, and a personal digital assistant (PDA). The information processing apparatus 200 transmits an image signal containing image data to the first projection system 100A via the cable 7.

The first projection system 100A and the second projection system 100B extract the image data contained in the image signal received from the information processing apparatus 200 and generate image light based on the extracted image data. The first projection system 100A and the second projection system 100B project the generated image light onto a projection receiving surface 10. An image corresponding to the image data is thus displayed on the projection receiving surface 10. As the projection receiving surface 10, a wall surface of a room may be used, or a screen may be installed.

The room where the information processing apparatus 200, the first projection system 100A, and the second projection system 100B are installed is provided with a small window 9, through which external light enters the room. The external light entering the room through the small window 9 makes a right region of the room that is the region provided with the small window 9 brighter than a left region of the room that is the region provided with the projection receiving surface 10.

### 2. Configuration of projection systems

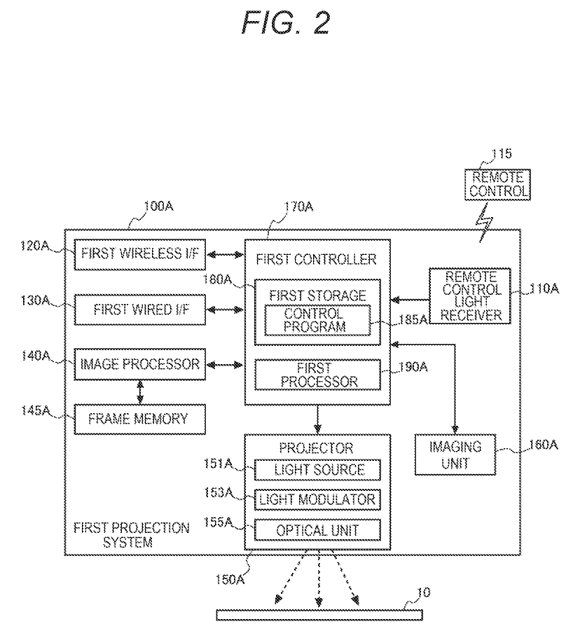

FIG. 2 is a block diagram showing the configuration of the first projection system 100A.

The first projection system 100A and the second projection system 100B have substantially the same configuration. Therefore, the configuration of the first projection system 100A will be described below, and the configuration of the second projection system 100B will not be described. Furthermore, in the following description, to distinguish the configurations of the first projection system 100A and the second projection system 100B from each other, "A" is added to the reference character of the configuration of the first projection system 100A, and "B" is added to the reference character of the configuration of the second projection system 100B.

The first projection system 100A includes a remote control light receiver 110A, a first wireless interface 120A, a first wired interface 130A, an image processor 140A, a frame memory 145A, a projector 150A, an imaging unit 160A, and a first controller 170A. The interface is hereinafter abbreviated to I/F.

The remote control light receiver 110A receives an infrared signal transmitted from a remote control 115, and outputs an operation signal corresponding to an operation content indicated by the received infrared signal to the first controller 170A.

The first wireless I/F 120A is an interface that performs wireless communication with an external apparatus including the information processing apparatus 200. The first wireless I/F 120A includes, for example, a wireless LAN card, performs the wireless communication with the external apparatus, and transmits and receives various pieces of information. The first wireless I/F 120A may include an interface circuit and a wireless antenna.

The first wired I/F 130A is an interface that is communicatively connected to the information processing apparatus 200 and the second projection system 100B, receives an image signal transmitted from the information processing apparatus 200, and transmits the received image signal to the second projection system 100B.

The first wired I/F 130A is, for example, an interface compliant with a standard such as HDMI, DisplayPort, and USB Type-C.

The frame memory 145A is coupled to the image processor 140A. The image processor 140A loads the image data input from the first wired I/F 130A into the frame memory 145A. The frame memory 145A is configured, for example, with a synchronous dynamic random access memory (SDRAM).

The image processor 140A performs image processing, such as resolution conversion or resizing, distortion correction, shape correction, digital zooming, and adjustment of the color tone and luminance of an image, on the image data loaded into the frame memory 145A. The image processor 140A performs image processing specified by the first controller 170A with a parameter input from the first controller 170A as required. The image processor 140A can, of course, perform some of the multiple types of image processing described above in combination. The image processor 140A reads the processed image data from the frame memory 145A, and outputs the read image data to the projector 150A.

The image processor 140A and the frame memory 145A are configured, for example, with an integrated circuit. Examples of the integrated circuit may include a large scale integrated circuit (LSI), an application specific integrated circuit (ASIC), a programmable logic device (PLD), a field-programmable gate array (FPGA), and a system-on-a-chip (SoC). Part of the configuration of the integrated circuit may be an analog circuit, and the first controller 170A and the integrated circuit may be combined with each other.

The projector 150A includes a light source 151A, a light modulator 153A, and an optical unit 155A.

The light source 151A includes a discharge type light source lamp such as an ultrahigh-pressure mercury lamp and a metal halide lamp, or a solid light source such as a light emitting diode and a semiconductor laser. Light output from the light source 151A is separated into red light, green light, and blue light by a color separation system that is not shown.

The light modulator 153A includes three liquid crystal panels corresponding to the red, green, and blue color components. Light modulation elements provided in the light modulator 153A are each not limited to a transmissive liquid crystal panel, and may, for example, be a reflective liquid crystal panel or a digital micromirror device (DMD).

The three types of color light separated into the red, green, and blue components by the color separation system enter the three liquid crystal panels corresponding to the red, green, and blue components, respectively. The liquid crystal panels are each configured with a transmissive liquid crystal panel in which a liquid crystal material is encapsulated between a pair of transparent substrates. In the liquid crystal panel, a pixel region configured with multiple pixels arranged in a matrix is formed, and a drive voltage is applicable to the liquid crystal material on a pixel basis.

The light modulator 153A includes a panel driver that drives each of the three liquid crystal panels corresponding to the color components. The panel driver applies a drive voltage according to the input image data to each of the pixels in the pixel region to cause the pixel, in each of the three liquid crystal panels, to have light transmittance according to the image data. The light output from the light source 151A passes through the pixel region of each of the liquid crystal panels and is therefore modulated on a pixel basis, so that image light corresponding to the image data is formed on a color light basis. The formed types of color image light are combined with one another on a pixel basis by a light combining system that is not shown to form image light representing a color image. The optical unit 155A includes a projection lens and the like, enlarges the image light modulated by the liquid crystal panels, and projects the enlarged image light onto the projection receiving surface 10. An image based on the image data is thus displayed on the projection receiving surface 10.

The imaging unit 160A corresponds to an camera. The imaging unit 160A includes an imaging lens and an imaging element such as a charge coupled device (CCD) and a complementary MOS (CMOS) device. The imaging lens and the imaging element are not shown in the figures. The imaging unit 160A captures an image of a range covering the projection receiving surface 10 in response to an instruction from the first controller 170A to generate a captured image. The imaging unit 160A outputs the generated captured image to the first controller 170A. Note that both the first projection system 100A and the second projection system 100B do not need to include the imaging units 160A and 160B, and at least one of the first projection system 100A and the second projection system 100B only needs to include the imaging unit 160A. The present embodiment will be described with reference to a case where the first projection system 100A includes the imaging unit 160A.

The first controller 170A is a computer apparatus including a first storage 180A and a first processor 190A.

The first storage 180A includes, for example, a read only memory (ROM) and a random access memory (RAM).

The ROM stores a control program 185A that controls the operation of the first projection system 100A and various types of set information. The RAM is used as a region where the first processor 190A performs of operation.

The first processor 190A is an operation processor including a processor such as a central processing unit (CPU) and a micro-processing unit (MPU). The first processor 190A can be configured with a single processor or multiple processors. The first processor 190A may be configured with an SoC integrated with a part or the entirety of the first storage 180A and other circuits. The first processor 190A may be configured with the combination of a CPU that executes a program and a digital signal processor (DSP) that performs predetermined operation. Furthermore, the first processor 190A may have a configuration in which all functions thereof are implemented in hardware, or may be configured with a programmable device.

### 3. Configuration of information processing apparatus

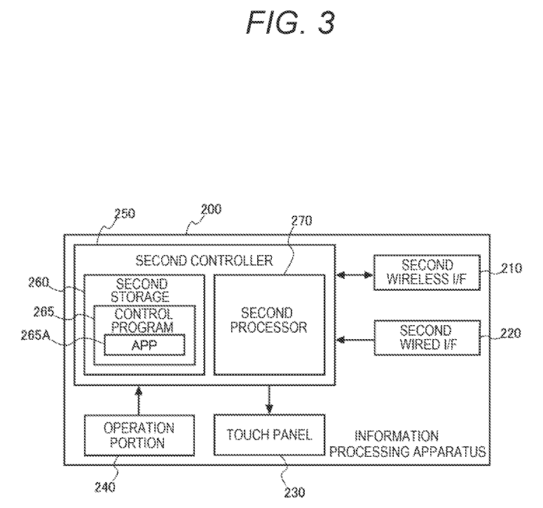

FIG. 3 is a block diagram showing the configuration of the information processing apparatus 200.

The configuration of the information processing apparatus 200 will be described with reference to FIG. 3.

The information processing apparatus 200 includes a second wireless I/F 210, a second wired I/F 220, a touch panel 230, an operation portion 240, and a second controller 250.

The second wireless I/F 210 is an interface that performs wireless communication with an external apparatus including the projection systems 100. The second wireless I/F 210 corresponds to an acquisition portion. For example, the second wireless I/F 210 includes a wireless LAN card, performs wireless communication with an external apparatus, and transmits and receives various pieces of information. The second wireless I/F 210 may include an interface circuit and a wireless antenna.

The second wired I/F 220 is communicatively connected to the first projection system 100A via the cable 7, and transmits an image signal to the first projection system 100A. The second wired I/F 220 is, for example, an interface including a terminal compliant with a standard such as HDMI, DisplayPort, and USB Type-C. The second wired I/F 220 may include an interface circuit.

The touch panel 230 corresponds to a display. The touch panel 230 includes a display panel such as a liquid crystal panel and an organic electro-luminescence (EL) panel, and a touch sensor that detects a touch operation performed on the touch panel 230. The touch sensor detects a user's touch operation, and outputs coordinate values indicating the position where the touch operation has been detected to the second controller 250. The coordinates are coordinate values in a coordinate system set at the display panel.

The operation portion 240 includes an input device such as a mouse and a keyboard, and accepts the user's operation. The operation portion 240 outputs an operation signal corresponding to the accepted operation to the second controller 250.

The second controller 250 is a computer apparatus including a second storage 260 and a second processor 270. The second controller 250 corresponds to a controller.

The second storage 260 includes, for example, a ROM and a RAM. The ROM stores a control program 265 that controls the operation of each portion of the information processing apparatus 200 and various pieces of set information. The control program includes an application program 265A. The application program 265A is hereinafter referred to as an APP 265A. The RAM is used as a region where the second processor 270 performsoperation. The second storage 260 may include an auxiliary storage device such as a hard disk drive (HDD) and a solid-state drive (SSD).

The second processor 270 is an operation processor including a processor such as a CPU and an MPU. The second processor 270 may be configured with a single processor or multiple processors. The second processor 270 may be configured with an SoC integrated with a part or the entirety of the second storage 260 and other circuits. The second processor 270 may be configured with the combination of a CPU that executes a program and a DSP that performs predetermined operation. Furthermore, the second processor 270 may have a configuration in which all functions thereof are implemented in hardware, or may be configured with a programmable device.

### 4. Operation of information processing apparatus

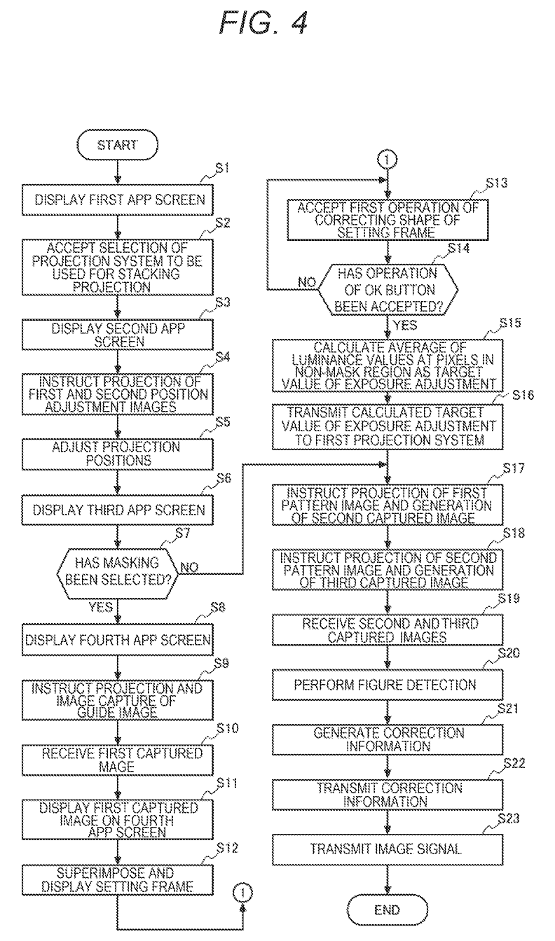

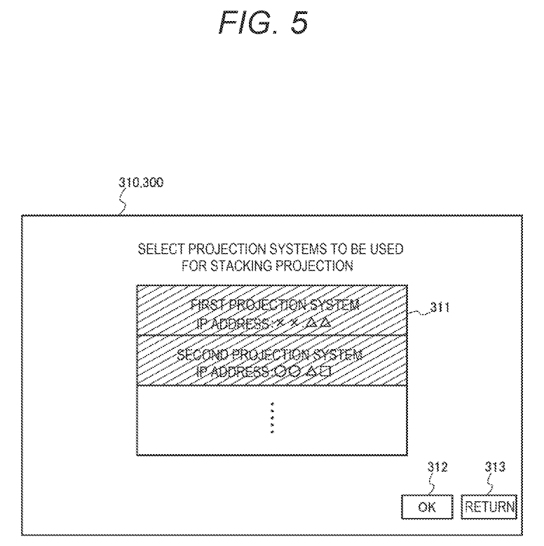

Operations of the information processing apparatus 200 that realize stacking projection using the multiple projection systems 100 will next be described with reference to the flowchart shown in FIG. 4, and FIGS. 5 to 10.

The stacking projection is a projection method of displaying an image brighter than one image projected by one projection system 100, the method including causing multiple projection systems 100 to project the same image multiple times in such a way that the multiple images are superimposed on each other. The operation of the information processing apparatus 200 will be described below with reference to a case where the two projection systems 100, the first projection system 100A and the second projection system 100B, perform the stacking projection.

The user first operates the operation portion 240 or the touch panel 230 to select the APP 265A. It is assumed in the following description that the user performs all operations through a touch operation performed on the touch panel 230. The APP 265A selected in the description is a program used to set the projection systems 100 to perform the stacking projection under the control of the information processing apparatus 200.

Upon acceptance of the operation of selecting the APP 265A, the second controller 250 executes the APP 265A selected by the accepted operation to cause the touch panel 230 to display an initial screen of an APP screen 300. The initial screen of the APP screen 300 is not shown. In the initial screen, tiling projection, edge blending, and the like can be set, as well as the stacking projection. The user perform a touch operation to select the stacking projection.

FIG. 5 shows an example of a first APP screen 310.

When the stacking projection is selected by the touch operation, the second controller 250 displays the first APP screen 310 shown in FIG. 5 (step S1). The first APP screen 310 is an example of the APP screen 300 displayed when the second processor 270 executes the APP 265A.

The first APP screen 310 displays a projection system selector 311, an OK button 312, and a return button 313. The projection system selector 311 displays information used to identify the projection systems 100 connected to the wireless network 5. The information used to identify the projection systems 100 contains, for example, the name and the IP address of each of the projection systems 100. The user touches and selects the projection systems 100 to be used for the stacking projection from the projection systems 100 to be identified by the information displayed in the projection system selector 311, and presses the OK button 312. The user can, of course, select multiple projection systems 100. When the OK button 312 is pressed, the second controller 250 accepts the operation of selecting projection systems 100 to be used for the stacking projection (step S2).

When the OK button 312 on the first APP screen 310 is pressed, the second controller 250 causes the touch panel 230 to display a second APP screen 320 (step S3). The second controller 250 then instructs the first projection system 100A to project a first position adjustment image 20, and instructs the second projection system 100B to project a second position adjustment image 30 (step S4).

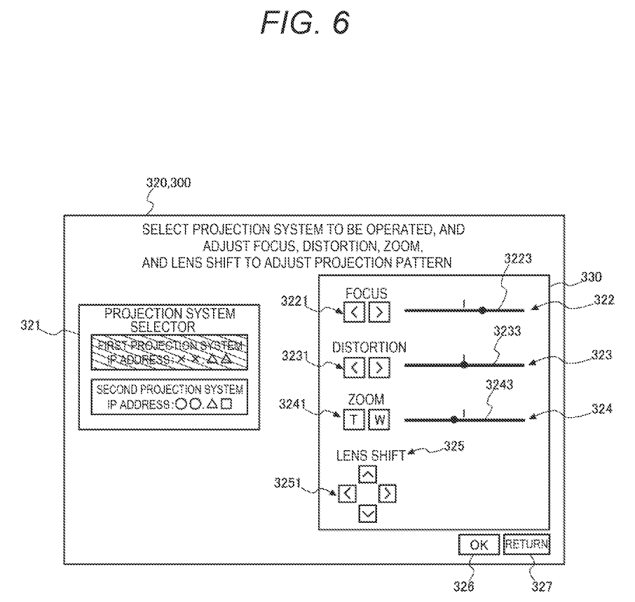

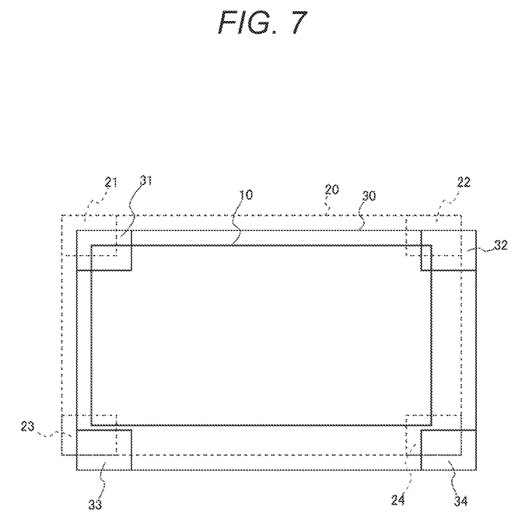

FIG. 6 shows an example of the second APP screen 320. FIG. 7 shows an example of the first position adjustment image 20 projected by the first projection system 100A on the projection receiving surface 10 and the second position adjustment image 30 projected by the second projection system 100B on the projection receiving surface 10.

The second APP screen 320 shown in FIG. 6 will first be described.

The second APP screen 320 is a screen that accepts the operation of adjusting the position of an image projected by each of the projection systems 100 with respect to the projection receiving surface 10.

The second APP screen 320 displays a projection system selector 321, an image adjuster 330, an OK button 326, and a return button 327.

The image adjuster 330 includes a focus setter 322, a distortion setter 323, a zoom setter 324, and a lens shift setter 325.

The projection system selector 321 accepts the operation of selecting the projection systems 100 to be operated. The projection system selector 321 displays the information used to identify the projection systems 100 selected by the projection system selector 311 shown in FIG. 5. The user selects the projection systems 100 to be adjusted in terms of the image projection position through a touch operation.

The focus setter 322 accepts the operation of changing the focus of the projection lens provided in each of the projection systems 100 selected by the projection system selector 321. The focus setter 322 includes an operator 3221, which accepts the user's operation, and a bar display 3223, which indicates a range adjustable by the operation of the operator 3221 and the current focus position.

The distortion setter 323 accepts the operation of changing the distortion produced by the projection lens provided in each of the projection systems 100 selected by the projection system selector 321. The distortion setter 323 includes an operator 3231, which accepts the user's operation, and a bar display 3233, which indicates a range over which the distortion can be changed by the operation of the operator 3231, and the current distortion.

The zoom setter 324 accepts the operation of changing the zoom of the projection lens provided in each of the projection systems 100 selected by the projection system selector 321. The zoom setter 324 includes an operator 3241, which accepts the user's operation, and a bar display 3243, over which the zoom can be changed by the operation of the operator 3241, and the current zoom position.

The lens shift setter 325 accepts the operation of changing the lens position of the projection lens provided in each of the projection systems 100 selected by the projection system selector 321. The lens shift setter 325 includes up, down, right, and left keys as an operator 3251.

The first position adjustment image 20, the second position adjustment image 30, and adjustment of the projection positions performed by using the first position adjustment image 20 and the second position adjustment image 30 will next be described with reference to FIG. 7.

The first position adjustment image 20 is an image in which rectangular FIGS. 21, 22, 23, and 24 are disposed at the four corners, as shown in FIG. 7, and the second position adjustment image 30 is also an image in which rectangular FIGS. 31, 32, 33, and 34 are disposed at the four corners, as shown in FIG. 7.

The projection position adjustment performed by using the second APP screen 320 only needs to be so performed that the FIGS. 21 and 31, the FIGS. 22 and 32, the FIGS. 23 and 33, and the FIGS. 24 and 34 partially overlap with each other, and that the first position adjustment image 20 and the second position adjustment image 30 are projected so as to cover the entire projection receiving surface 10, for example, as shown in FIG. 7.

That is, the first position adjustment image 20 and the second position adjustment image 30 do not need to overlap with each other in such a way that the vertices at the four corners of the first position adjustment image 20 and those of the second position adjustment image 30 completely coincide with each other.

The user operates the image adjuster 330 in the second APP screen 320 while referring to the first position adjustment image 20 and the second position adjustment image 30 projected onto the projection receiving surface 10 to adjust the projection positions of the first position adjustment image 20 and the second position adjustment image 30 (step S5).

That is, the user operates the image adjuster 330 in such a way that the FIGS. 21 and 31, the FIGS. 22 and 32, the FIGS. 23 and 33, and the FIGS. 24 and 34 of the first position adjustment image 20 and the second position adjustment image 30 partially overlap with each other. Similarly, the user operates the image adjuster 330 in such a way that the first position adjustment image 20 and the second position adjustment image 30 cover the entire projection receiving surface 10.

Upon acceptance of the operation of changing the focus, the distortion, the zoom, or the lens shift via the second APP screen 320, the second controller 250 transmits a control signal corresponding to the accepted operation to the relevant projection system 100. The following description will be made on the assumption that the first projection system 100A is selected by the projection system selector 321 and the second controller 250 transmits the control signal to the first projection system 100A. The first controller 170A of the first projection system 100A changes the focus, the distortion, the zoom, or the lens position of the projection lens in accordance with the control signal received from the information processing apparatus 200.

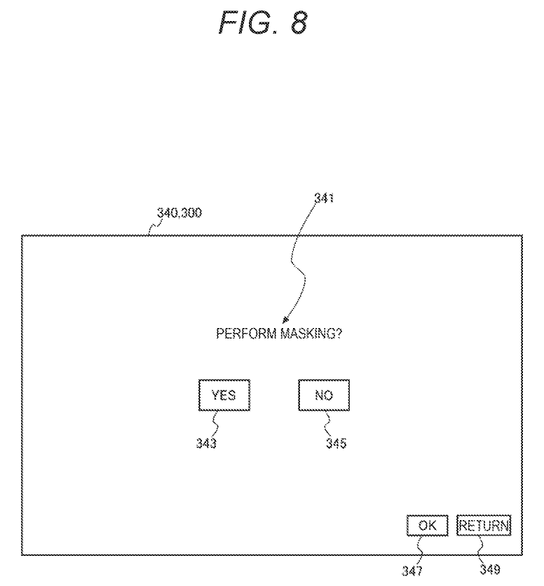

FIG. 8 shows an example of a third APP screen 340. The third APP screen 340 is an example of the APP screen 300 displayed when the second processor 270 executes the APP 265A.

When the projection position adjustment performed by using the second APP screen 320 ends, and the OK button 326 is pressed, the second controller 250 causes the touch panel 230 to display the third APP screen 340 shown in FIG. 8 (step S6). The third APP screen 340 shown in FIG. 8 displays a guidance display 341, which inquires whether to perform masking that limits the range of exposure adjustment, a YES button 343, a NO button 345, an OK button 347, and a return button 349.

To perform the masking, the user selects the YES button 343 and presses the OK button 347. To perform no masking, the user selects the NO button 345 and presses the OK button 347. The second controller 250 determines whether the masking has been selected based on the operation accepted via the third APP screen 340 (step S7).

When the NO button 345 is selected in the third APP screen 340, and the OK button 347 is pressed, the second controller 250 determines that the masking has not been selected (NO in step S7). In this case, the second controller 250 proceeds to the process in step S17. The process in step S17 will be described later in detail.

When the YES button 343 is selected in the third APP screen 340, and the OK button 347 is pressed, the second controller 250 determines that the masking has been selected (YES in step S7). In this case, the second controller 250 causes the touch panel 230 to display a fourth APP screen 350, and instructs projection and image capture of a guide image 40 (step S9). The flowchart shown in FIG. 4 is described with reference to a case where the first projection system 100A projects the guide image 40, but the second projection system 100B may project the guide image 40.

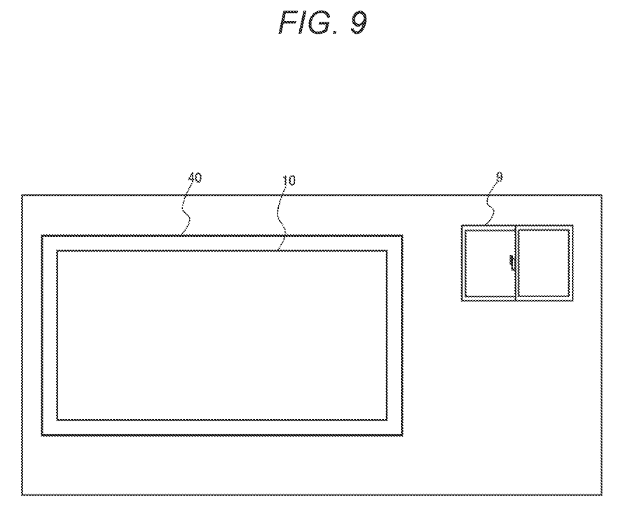

FIG. 9 shows an example of the guide image 40 projected by the first projection system 100A onto the projection receiving surface 10. The guide image 40 is a black frame image formed at the four edges of the guide image 40. The guide image 40 is not limited to the example shown in FIG. 9, and may, for example, be an image in which a figure having any shape is disposed in a range covering the four corners of the guide image 40.

The first projection system 100A projects the guide image 40 onto the projection receiving surface 10 in accordance with an instruction from the information processing apparatus 200. In the projection position adjustment in step S5, the first position adjustment image 20 is adjusted so as to cover the entire projection receiving surface 10. The guide image 40 projected by the first projection system 100A is therefore also projected so as to cover the entire projection receiving surface 10.

The first projection system 100A then captures an image of a range covering the projection receiving surface 10 onto which the guide image 40 has been projected to generate a captured image. This captured image is referred to as a first captured image 400. The first projection system 100A transmits the generated first captured image 400 to the information processing apparatus 200.

The second controller 250 receives the first captured image 400 transmitted by the first projection system 100A (step S10), and displays the received first captured image 400 on the fourth APP screen 350 (step S11).

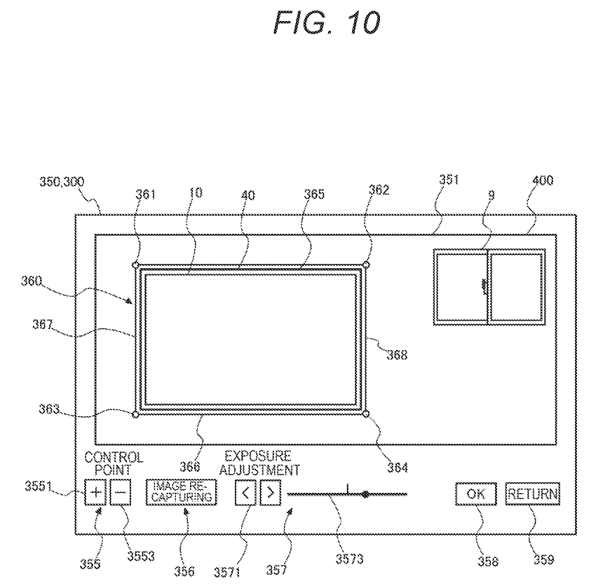

FIG. 10 shows an example of the fourth APP screen 350. The fourth APP screen 350 is an example of the APP screen 300 displayed when the second processor 270 executes the APP 265A.

The fourth APP screen 350 will now be described.

The fourth APP screen 350 displays an image display screen 351, a control point number change operation portion 355, an image-recapturing button 356, an exposure adjuster 357, an OK button 358, and a return button 359.

The second controller 250 displays the first captured image 400 received from the first projection system 100A in the image display screen 351 of the fourth APP screen 350. The first captured image 400 is an image containing the guide image 40.

The second controller 250 superimposes and displays a setting frame 360 on the first captured image 400 displayed in the image display screen 351 (step S12).

The setting frame 360 shown in FIG. 10 includes control points 361, 362, 363, and 364 disposed at the four vertices of the setting frame 360, and four line segments 365, 366, 367, and 368, which link the control points 361, 362, 363, and 364 to each other.

The setting frame 360 is an image of a frame that sets a non-mask region where the masking is not performed.

The exterior of the setting frame 360 is a mask region where the masking is performed, and the interior of the setting frame 360 is the non-mask region, where the masking is not performed. For example, when the first captured image 400 contains external light entering the room through the small window 9 shown in FIG. 10, the exposure adjustment is performed with respect to the luminance of the external light having entered the room. As a result, the projection image captured in the first captured image 400 is displayed at dark luminance, and the positional relationship between the projection image and the projection receiving surface 10 cannot be recognized in some cases.

The second controller 250 accepts a first operation of correcting the shape and the position of the setting frame 360 through a touch operation (step S13). For example, the user performs the first operation of correcting the position and the shape of the setting frame 360 through the touch operation while referring to the guide image 40 displayed in the first captured image 400. The user changes the positions of the control points 361, 362, 363, and 364 through touch operations to change the position and the shape of the setting frame 360. The user thus sets the non-mask region.

As will be described later, the second controller 250 masks the region in the first captured image 400 but outside the setting frame 360, and calculates the average of luminance values at the pixels in the region in the first captured image 400 and inside the setting frame 360 as a target value in the exposure adjustment.

In this operation, it is preferable that the setting frame 360 set by the user is so set that the ratio of the area of the guide image 40 to the area enclosed by the setting frame 360 is large. The reason for this is to suppress a decrease in the accuracy of the exposure adjustment due to the fact that the target value of the exposure adjustment becomes smaller than the luminance value of the guide image 40 when the ratio of the area enclosed by the setting frame 360 set by the user to the area of the guide image 40 is small.

The second controller 250 then determines whether the OK button 358 has been operated (step S14). When the OK button 358 has not been operated (NO in step S14), the second controller 250 returns to the process in step S10 and accepts the first operation.

When the non-mask region is set in the first captured image 400 by the user's operation, and the OK button 358 is pressed (YES in step S14), the second controller 250 calculates the target value of the exposure adjustment (step S15).

The second controller 250 masks the region in the first captured image 400 but outside the setting frame 360. For example, the second controller 250 calculates the average of the luminance values at the pixels in the region in the first captured image 400 and inside the setting frame 360. The second controller 250 sets the calculated average luminance value as the target value of the exposure adjustment. A decrease in the accuracy of the detection of an image projected by the projection apparatus from the captured image due to the luminance values of the projection receiving surface 10 can thus be suppressed. The second controller 250 then transmits the set target value of the exposure adjustment to the first projection system 100A as the control information (step S16). The second controller 250 may instead generate control information used to adjust a set value of at least one of the shutter speed, the gain, and the aperture of the imaging unit 160A in such a way that the average of the luminance values of the first captured image 400 captured by the imaging unit 160A becomes the target value of the exposure adjustment, and transmit the generated control information to the first projection system 100A. Note that the target value of the exposure adjustment may be the average of the luminance values at the pixels where the luminance values are greater than or equal to a first predetermined value out of the luminance values at the pixels in the region in the first captured image 400 and inside the setting frame 360. The first predetermined value is, for example, the lower limit of the luminance values of the projection receiving surface 10.

The first controller 170A of the first projection system 100A adjusts a set value of at least one of the shutter speed, the gain, and the aperture of the imaging unit 160A based on the target value of the exposure adjustment indicated by the control information received from the information processing apparatus 200. The first controller 170A instead adjusts a set value of at least one of the shutter speed, the gain, and the aperture of the imaging unit 160A in accordance with the control information received from the information processing apparatus 200.

Having adjusted a set value of at least one of the shutter speed, the gain, and the aperture of the imaging unit 160A to generate the first captured image 400, the first controller 170A transmits the generated first captured image 400 to the information processing apparatus 200.

FIG. 10 shows the rectangular setting frame 360, and the setting frame 360 does not necessarily have a rectangular shape. The control point number change operation portion 355 includes an operator 3551, which increases the number of control points, and an operator 3553, which decreases the number of control points. The number of control points can be changed by operating the operator 3551 or the operator 3553. The operation of the operator 3551 or the operation of the operator 3553 corresponds to a third operation. For example, the setting frame 360 may have a polygonal shape such as a triangular, pentagonal, or hexagonal shape. The user presses the operator 3551 and then touches any of the line segments 365, 366, 367, and 368, which constitute the setting frame 360, to add a new control point to the touched position on one of the line segments 365, 366, 367, and 368.

The image-recapturing button 356 is a button that causes the first projection system 100A to capture the first captured image 400 again. When the image-recapturing button 356 is pressed, the second controller 250 instructs the first projection system 100A to perform image capture again. The first captured image 400 re-captured by the first projection system 100A is thus displayed in the image display screen 351.

The exposure adjuster 357 includes an operator 3571, which accepts the operation of increasing or decreasing the calculated target luminance value, and a bar display 3573, which indicates the exposure adjustment range and the current exposure set position. The user can change to increase or decrease the target luminance value by operating the operator 3571. The operation of the operator 3571 and the operation of the image-recapturing button 356 correspond to a second operation. When the operator 3571 is operated, and the image-recapturing button 356 is operated, the changed target value of the exposure adjustment is transmitted as the control information to the first projection system 100A.

The first controller 170A of the first projection system 100A adjusts a set value of at least one of the shutter speed, the gain, and the aperture of the imaging unit 160A based on the target value of the exposure adjustment indicated by the control information received from the information processing apparatus 200. The first controller 170A instead adjusts a set value of at least one of the shutter speed, the gain, and the aperture of the imaging unit 160A in accordance with the control information received from the information processing apparatus 200. Having adjusted a set value of at least one of the shutter speed, the gain, and the aperture of the imaging unit 160A, the first controller 170A generates the first captured image 400, and transmits the generated first captured image 400 to the information processing apparatus 200. The image display screen 351 thus displays the first captured image 400 having undergone the exposure adjustment in accordance with the control information generated by the second controller 250.

The second controller 250 then instructs the first projection system 100A to project a first pattern image and generate a captured image (step S17). The first pattern image is, for example, an image in which figures having a preset shape are arranged at preset intervals in the vertical direction and the horizontal direction of the pattern image. The figures may each, for example, be a circle, a triangle, or a quadrangle.

The first projection system 100A projects the pattern image onto the projection receiving surface 10 in response to an instruction from the information processing apparatus 200, and causes the imaging unit 160A to capture an image of the projection receiving surface 10 onto which the pattern image has been projected to generate a captured image. The captured image is referred to as a second captured image. The first projection system 100A transmits the generated second captured image to the information processing apparatus 200.

The second controller 250 then instructs the second projection system 100B to project a second pattern image and instructs the first projection system 100A to generate a captured image (step S18). The second pattern image may be the same as or different from the first pattern image. The first pattern image and the second pattern image may be patterns in which figures are arranged to identify a position by the first pattern image and the second pattern image, and the figures arranged in the first pattern image and the second pattern image may, for example, have different shapes.

The second projection system 100B projects the second pattern image onto the projection receiving surface 10 in response to an instruction from the information processing apparatus 200. The first projection system 100A causes the imaging unit 160A to capture an image of the projection receiving surface 10 onto which the second pattern image has been projected to generate a captured image. The captured image is referred to as a third captured image. The first projection system 100A transmits the generated third captured image to the information processing apparatus 200.

The second controller 250 receives the second captured image and the third captured image transmitted from the first projection system 100A (step S19). The second controller 250 having acquired the second captured image and the third captured image performs figure detection (step S20).

As the figure detection, the second controller 250 performs image analysis on the second captured image, detects the figures contained in the pattern image, and identifies the positions of the detected figures in the second captured image.

Similarly, as the figure detection, the second controller 250 performs image analysis on the third captured image, detects the figures contained in the pattern image, and identifies the positions of the detected figures in the third captured image.

The second controller 250 then generates correction information (step S21). The correction information is information used to match the positions of the figures contained in the second captured image with the positions of the figures contained in the third captured image. For example, the second controller 250 generates correction information used to correct the positions of the figures contained in the second captured image to the positions of the corresponding figures contained in the third captured image.

Having generated the correction information, the second controller 250 outputs the generated correction information to at least one of the first projection system 100A and the second projection system 100B (step S22). It is assumed in the description that the correction information is output only to the first projection system 100A.

The second controller 250 then transmits an image signal containing image data to the first projection system 100A via the cable 7 (step S23). Upon reception of the image signal from the information processing apparatus 200, the first projection system 100A captures the received image signal and transmits the image signal to the second projection system 100B.

Upon reception of the image signal from the information processing apparatus 200, the first projection system 100A acquires the image data contained in the received image signal, and corrects the acquired image data based on the correction information. The first projection system 100A generates image light based on the image data corrected based on the correction information. The first projection system 100A projects the generated image light onto the projection receiving surface 10. The second projection system 100B also generates image light based on the image data, and projects the generated image light onto the projection receiving surface 10.

The second projection system 100B generates image light based on the image data and projects the generated image light onto the projection receiving surface 10, so that the image projected by the first projection system 100A and the image projected by the second projection system 100B are superimposed on each other, resulting in the stacking projection.

### 5. Modifications

The aforementioned embodiment has been described with reference to the case where the stacking projection is performed by the two projection systems 100, the first projection system 100A and the second projection system 100B. Even when the position and the shape of an image projected by one projection system 100 are corrected, carrying out the processes in steps S1 to S13 in the flowchart shown in FIG. 4 allows preferable exposure adjustment even when external light is captured and contained in the captured image. Therefore, capturing the pattern image projected onto the projection receiving surface 10 with the imaging unit 160A having undergone the exposure adjustment allows accurate correction of the position and the shape of the image projected by one projection system 100.

The embodiment described above is a preferable embodiment of the present disclosure. The present disclosure is, however, not limited to the embodiment described above, and various modifications are conceivable to the extent that the modifications do not depart from the key points of the present disclosure.

For example, the aforementioned embodiment has been described with reference to the case where the information processing apparatus 200 is operated as the control apparatus, and the first projection system 100A or the second projection system 100B may be operated as the control apparatus. Furthermore, the aforementioned embodiment has been described with reference to the case where the first projection system 100A includes the imaging unit 160A, and the information processing apparatus 200 may be provided with the imaging unit 160B, or the camera may be provided outside the first projection system 100A or the information processing apparatus 200.

In the embodiment described above, the light modulator 153A including the liquid crystal panels is presented by way of example, and the liquid crystal panels may each be a transmissive liquid crystal panel or a reflective liquid crystal panel. The light modulator 153A may have a configuration in which the liquid crystal panels are replaced with digital mirror devices. The digital mirror devices and a color wheel may be combined with each other. The light modulator 153A may employ a configuration capable of modulating the light output by the light source in place of the liquid crystal panels and the digital mirror devices.

Each of the functional portions of the information processing apparatus 200 shown in FIG. 3 represents a functional configuration, and is not necessarily implemented in a specific form. That is, hardware corresponding to each of the functional portions is not necessarily implemented, and a single processor can, of course, execute a program to achieve the functions of the multiple functional portions. Furthermore, in the embodiment described above, a part of the functions achieved by software may be achieved by hardware, or a part of the functions achieved by hardware may be achieved by software. In addition, the specific detailed configuration of each of the other portions of each of the projection systems can be freely changed to the extent that the change does not depart from the intent of the present disclosure. The same holds true for the configurations of the first projection system 100A and the second projection system 100B shown in FIG. 2.

The process units in the flowchart shown in FIG. 4 are process units into which the processes carried out by the information processing apparatus 200 are divided in accordance with the contents of the primary processes to facilitate understanding of the processes. How to produce the divided process units shown in the flowchart of FIG. 4 or the names of the process units do not limit the present disclosure. A process carried out by the information processing apparatus 200 can be further divided into a larger number of process units in accordance with the content of the process, or can be divided such that each of the process units has a larger number of processes. Furthermore, the order in which the processes are carried out in the flowchart described above is not limited to that shown in FIG. 4.

### 6. Summary of present disclosure

The present disclosure is summarized below as additional remarks.

### Additional Remark 1

An exposure adjustment method including: causing a control apparatus to acquire a captured image from an camera, the captured image being a result of capturing an image of a range covering a projection receiving surface onto which an image is projected, display the acquired captured image, accept a first operation of correcting a shape and a position of a non-mask region in the captured image, set the non-mask region in the captured image based on the first operation, calculate a target value of exposure adjustment based on the non-mask region in the captured image, and output the calculated target value to the camera; and causing the camera to adjust a set value of at least one of a shutter speed, a gain, and an aperture of the camera based on the target value.

Therefore, even when external light or the like is incident on a region other than the non-mask region and the luminance of the region becomes higher than that of the projected image, the target value of the exposure adjustment is calculated based on the captured image in the non-mask region, and the exposure adjustment is performed in the camera based on the calculated target value. The exposure adjustment of the camera can therefore be optimally performed, so that a decrease in the accuracy of detection of the range of the projection receiving surface from the captured image captured by the camera can be suppressed.

### Additional Remark 2

The exposure adjustment method according to Additional Remark 1, wherein the control apparatus, before setting the non-mask region in the captured image, is configured to accept a second operation of changing the target value, and output the changed target value to the camera, the camera is configured to adjust the set value of the camera based on the changed target value, and capture an image of the range covering the projection receiving surface to generate a captured image, and output the captured image to the control apparatus, and the control apparatus is configured to display the captured image.

Therefore, changing the target value of the exposure adjustment and displaying the captured image captured by the camera having undergone the exposure adjustment based on the changed target value allows improvement in the visibility of the range of the projection receiving surface in the captured image when the user corrects the shape and the position of a setting frame.

### Additional Remark 3

The exposure adjustment method according to Additional Remark 1 or 2, wherein the non-mask region has a polygonal shape having five or more vertices that serve as control points.

Therefore, setting the non-mask region with a polygonal shape having five or more vertices that serve as the control points allows the non-mask region to be set in accordance with the shape of the projection receiving surface even when the projection receiving surface has a polygonal shape or a shape having a curved surface having five or more vertices.

### Additional Remark 4

The exposure adjustment method according to Additional Remark 1 or 2, further comprising: accepting a third operation of changing the number of control points that define the shape of the non-mask region; and setting the non-mask region in the captured image with a polygonal shape having vertices that serve as the control points the number of which is changed by the third operation.

Therefore, even when the range of the projection receiving surface has a complicated shape, the non-mask region can be set with a polygonal shape corresponding to the complicated shape by increasing or decreasing the number of the control points.

### Additional Remark 5

An image correction method including: causing a first projection apparatus to project a guide image used to guide setting of a non-mask region; causing a control apparatus to acquire a first captured image from an camera, the first captured image being a result of capturing an image of a range covering the projected guide image; causing the control apparatus to display the acquired first captured image; causing the control apparatus to accept a first operation of correcting a shape and a position of the non-mask region set based on the guide image displayed in the first captured image; causing the control apparatus to set the non-mask region in the first captured image based on the first operation; causing the control apparatus to calculate a target value of exposure adjustment based on the non-mask region in the first captured image; causing the control apparatus to output the calculated target value to the camera; causing the camera to adjust a set value of at least one of a shutter speed, a gain, and an aperture of the camera based on the target value, causing a first projection apparatus to project a first pattern image having a predetermined pattern; causing the control apparatus to acquire a second captured image captured with the camera the set value of which is adjusted based on the target value and including the first pattern image; causing a second projection apparatus to project a second pattern image having a predetermined pattern; causing the control apparatus to acquire a third captured image captured with the camera the set value of which is adjusted based on the target value and including the second pattern image; and causing the control apparatus to correct a shape of an image projected by at least one of the first projection apparatus and the second projection apparatus based on the second captured image and the third captured image.

The second captured image containing the first pattern image and the third captured image containing the second pattern image are thus captured by the camera the set value of which has been adjusted. The shape of the image projected by at least one of the first projection apparatus and the second projection apparatus is corrected based on the second captured image and the third captured image. The shape of the image projected by at least one of the first projection apparatus and the second projection apparatus can therefore be accurately corrected.

### Additional Remark 6

An exposure adjustment system including: a control apparatus including an acquisition portion configured to acquire a captured image from an camera, the captured image being a result of capturing an image of a range covering a projection receiving surface onto which an image is projected, a display screen configured to display the acquired captured image, an operation portion configured to accept a first operation of correcting a shape and a position of a non-mask region in the captured image, and a controller configured to set the non-mask region in the captured image based on the first operation, calculate a target value of exposure adjustment based on the non-mask region in the captured image, and output the calculated target value to the camera; and the camera configured to adjust a set value of at least one of a shutter speed, a gain, and an aperture of the camera based on the target value.

Therefore, even when external light or the like is incident on a region other than the non-mask region and the luminance of the region becomes higher than that of the projected image, the target value of the exposure adjustment is calculated based on the captured image in the non-mask region, and the exposure adjustment is performed in the camera based on the calculated target value. The exposure adjustment of the camera can therefore be optimally performed, so that a decrease in the accuracy of detection of the range of the projection receiving surface from the captured image captured by the camera can be suppressed.

### Additional Remark 7

The exposure adjustment system according to Additional Remark 6, wherein before the control apparatus sets the non-mask region in the captured image, the controller is configured to accept a second operation of changing the target value via the operation portion, and output the changed target value to the camera, the camera is configured to adjust the set value of the camera based on the changed target value, capture an image of the range covering the projection receiving surface to generate a captured image, and output the captured image to the control apparatus, and the controller is configured to display the captured image on the display screen.

Therefore, changing the target value of the exposure adjustment and displaying the captured image captured by the camera having undergone the exposure adjustment based on the changed target value allows improvement in the visibility of the range of the projection receiving surface in the captured image when the user corrects the shape and the position of the setting frame.

### Additional Remark 8

The exposure adjustment system according to Additional Remark 6 or 7, wherein the non-mask region has a polygonal shape having five or more vertices.

Therefore, setting the non-mask region with a polygonal shape having five or more vertices that serve as the control points allows the non-mask region to be set in accordance with the shape of the projection receiving surface even when the projection receiving surface has a polygonal shape or a shape having a curved surface having five or more vertices.

What is claimed is:

1. An exposure adjustment method comprising:
causing a control apparatus to
acquire a captured image from an camera, the captured image being a result of capturing an image of a range covering a projection receiving surface onto which an image is projected,
display the acquired captured image,
accept a first operation of correcting a shape and a position of a non-mask region in the captured image,
set the non-mask region in the captured image based on the first operation,
calculate a target value of exposure adjustment based on the non-mask region in the captured image, and
output the calculated target value to the camera; and
causing the camera to adjust a set value of at least one of a shutter speed, a gain, and an aperture of the camera based on the target value.

2. The exposure adjustment method according to claim 1, wherein
the control apparatus, before setting the non-mask region in the captured image, is configured to
accept a second operation of changing the target value, and
output the changed target value to the camera,
the camera is configured to
adjust the set value of the camera based on the changed target value,
capture an image of the range covering the projection receiving surface to generate a captured image, and
output the captured image to the control apparatus, and
the control apparatus is configured to display the captured image.

3. The exposure adjustment method according to claim 1, wherein
the non-mask region has a polygonal shape having five or more vertices that serve as control points.

4. The exposure adjustment method according to claim 1, further comprising:
accepting a third operation of changing the number of control points that define the shape of the non-mask region; and
setting the non-mask region in the captured image with a polygonal shape having vertices that serve as the control points the number of which is changed by the third operation.

5. An image correction method comprising:
causing a first projection apparatus to project a guide image used to guide setting of a non-mask region;
causing a control apparatus to acquire a first captured image from an camera, the first captured image being a result of capturing an image of a range covering the projected guide image;
causing the control apparatus to display the acquired first captured image;
causing the control apparatus to accept a first operation of correcting a shape and a position of the non-mask region set based on the guide image displayed in the first captured image;
causing the control apparatus to set the non-mask region in the first captured image based on the first operation;
causing the control apparatus to calculate a target value of exposure adjustment based on the non-mask region in the first captured image;
causing the control apparatus to output the calculated target value to the camera;
causing the camera to adjust a set value of at least one of a shutter speed, a gain, and an aperture of the camera based on the target value;
causing a first projection apparatus to project a first pattern image having a preset pattern;
causing the control apparatus to acquire a second captured image captured with the camera the set value of which is adjusted based on the target value and including the first pattern image;
causing a second projection apparatus to project a second pattern image having a preset pattern;
causing the control apparatus to acquire a third captured image captured with the camera the set value of which is adjusted based on the target value and including the second pattern image; and
causing the control apparatus to correct a shape of an image projected by at least one of the first projection apparatus and the second projection apparatus based on the second captured image and the third captured image.

6. An exposure adjustment system comprising:
a control apparatus including
an acquisition portion configured to acquire a captured image from an camera, the captured image being a result of capturing an image of a range covering a projection receiving surface onto which an image is projected,
a display screen configured to display the acquired captured image,
an operation portion configured to accept a first operation of correcting a shape and a position of a non-mask region in the captured image, and
a controller configured to
set the non-mask region in the captured image based on the first operation,
calculate a target value of exposure adjustment based on the non-mask region in the captured image, and
output the calculated target value to the camera; and
the camera configured to adjust a set value of at least one of a shutter speed, a gain, and an aperture of the camera based on the target value.

7. The exposure adjustment system according to claim 6, wherein before the control apparatus sets the non-mask region in the captured image,
the controller is configured to
accept a second operation of changing the target value via the operation portion, and
output the changed target value to the camera,
the camera is configured to
adjust the set value of the camera based on the changed target value, and
capture an image of the range covering the projection receiving surface to generate a captured image, and
output the captured image to the control apparatus, and
the controller is configured to display the captured image on the display screen.

8. The exposure adjustment system according to claim 6, wherein
the non-mask region has a polygonal shape having five or more vertices.
